(19) United States
(12) Patent Application Publication
(10) Pub. No.: US 2026/0037006 A1
(43) Pub. Date: Feb. 5, 2026

(54) SYSTEM FOR, AND METHOD OF, REMOTELY OPERATING A VEHICLE IN A LOGISTICS INVENTORY MANAGEMENT FACILITY

(71) Applicant: All Terminal Services, LLC (d/b/a ConGlobal Technologies), Westmont, IL (US)

(72) Inventors: Brett Bartlett Rogers, West Point, UT (US); Patrick John Hald, Ogden, UT (US)

(21) Appl. No.: 19/288,736

(22) Filed: Aug. 1, 2025

Related U.S. Application Data
(60) Provisional application No. 63/678,178, filed on Aug. 1, 2024.

(51) Int. Cl. G05D 1/698; G05D 1/692; G05D 107/70; G06Q 10/087

(52) U.S. Cl. CPC G05D 1/6987; G05D 1/692; G06Q 10/0874; G05D 2107/70

(57) ABSTRACT

A system for, and method of, remotely operating one or more vehicles in one or more inventory management facilities including one or more assets. The system and method include vehicles configured to move one or more assets in one or more inventory management facilities from a first location to a second location and a control station in communication with the one or more vehicles. The control station is remote from the one or more vehicles and communicates at least one operational command to the one or more vehicles to operate the one or more vehicles to perform one or more assigned tasks and/or operational workflows for the one or more vehicles.

### CROSS-REFERENCE TO RELATED APPLICATIONS

This application claims the benefit of U.S. Provisional Application 63/678,178 filed on Aug. 1, 2024, the disclosures of which is incorporated herein by reference in its entirety.

### FIELD OF THE INVENTION

The present invention relates generally to the field of supply chain logistics, and more particularly, to a system for, and method of, remotely operating a vehicle in an inventory management facility.

### BACKGROUND OF THE INVENTION

Supply chain logistics is a major international industry that involves the movement of freight between and within different inventory management facilities before the freight arrives at its final destination.

During transportation, freight may be switched between one or more modes of transport to another, for example, using an asset such as an intermodal container, chassis, and/or semi-trailer moved (e.g., pulled) by a ground vehicle. During transportation, these assets, such as containers, chassis, and trailers, may be stored in, and/or moved between, one or more inventory management facilities or within one or more parts or regions thereof. For example, an inventory management facility includes one or more of a yard, terminal, warehouse, an order fulfillment facility, distribution center, container yard, logistics park, intermodal storage facility, etc., which supports storage and transportation of freight via one or more different modes of transportation. In an example, an inventory management facility may be arranged in lots, each with multiple rows of assets, such as containers, chassis, and/or trailers, each row including several slots or parking spaces, and each slot able to accommodate one or more assets, such as one or more containers (e.g., individual or stacked), chassis, trailers, or one or more other assets.

Conventional systems for an inventory management facility, such as a yard, terminal, warehouse, distribution center, container yard, logistics park, etc., may utilize one or more vehicles, such as a yard truck, to move assets from a first location to a second location within the inventory management facility or between one or more inventory management facilities. In such conventional systems, a local human operator commonly is onboard the vehicle and operates the vehicle from within the vehicle's cab so that the local operator has a line-of-site with the surrounding environment of the vehicle to control the operation and movement of the vehicle to thereby move assets within the inventory management facility or between one or more inventory management facilities.

### BRIEF SUMMARY OF THE INVENTION

The present invention recognizes that, since conventional systems for an inventory management facility require a local human operator to operate the yard truck from onboard the vehicle, such as within the vehicle's cab, the operator may be exposed to the local environmental conditions of the inventory management facility, such as high or low temperatures or humidity, inclement weather, etc. An individual operator must be physically present and onboard each vehicle to operate the vehicle and perform a workflow within an inventory management facility or between inventory management facilities. Commonly, the individual operator must remain physically present with the vehicle throughout a workflow in or between the inventory management facilities, including during times during a workflow in which the vehicle is stationary, such as when the vehicle is parked, waiting in line with other vehicles, waiting in a queue with other vehicles, etc. for its turn to move or proceed from one location to another, to be attended to, to be loaded and/or unloaded with freight, to be connected and/or disconnected with an asset, to be docked and/or moved from a dock, etc.

Many inventory management facilities have lengthy hours of operation, with some operating 24 hours a day/7 days a week, which commonly requires staffing multiple shifts of vehicle operators to operate one or more vehicles in the inventory management facility throughout the hours of operation, including shifts during daylight and nighttime hours.

These challenges and others are addressed by the present invention, a first exemplary embodiment of which comprises a system for remotely operating one or more vehicles in one or more inventory management facilities including one or more assets, the system comprising the one or more vehicles configured to move one or more assets in the one or more inventory management facilities from a first location to a second location, a control station in communication with the one or more vehicles, wherein the control station is remote from the one or more vehicles and communicates at least one operational command to the one or more vehicles to operate the one or more vehicles to perform one or more assigned tasks and/or operational workflows for the one or more vehicles.

In embodiments, the one or more assigned tasks and/or operational workflows for the one or more vehicles includes moving a first asset of the one or more assets in the one or more inventory management facilities from a first location in the one or more inventory management facilities to a second location in the one or more inventory management facilities.

The control station includes, for example, a computer or server or a combination thereof including one or more processors and one or more non-transitory computer-readable storage mediums storing instructions comprising one or more algorithms that when executed by the one or more processors cause the one or more processors to perform steps. The control station includes, for example, an operator console. The operator console includes, for example, a screen, display, or the like for conveying information to the operator. The operator console includes, for example, operation controls such as a steering wheel, accelerator, brake, transmission actuator, turn indicator actuator, or other operation controls, or combinations thereof for remotely operating one or more vehicles.

Another exemplary embodiment of which comprises a method of remotely operating one or more vehicles in one or more inventory management facilities including one or more assets, the method comprising the steps of initiating a connection to a first vehicle of the one or more vehicles, assuming operational control of the first vehicle, and performing one or more assigned tasks and/or operational workflows for the first vehicle. The step of performing one or more assigned tasks and/or operational workflows for the first vehicle includes moving a first asset of the one or more assets in the one or more inventory management facilities from a first location in the one or more inventory management facilities to a second location in the one or more inventory management facilities.

Another exemplary embodiment of which comprises a server for controlling remotely operating one or more vehicles in one or more inventory management facilities including one or more assets, wherein the server is in communication with one or more sensors configured to generate sensor data of the one or more assets in the inventory management facility, the server comprising one or more processors and one or more non-transitory computer-readable storage mediums storing instructions comprising one or more algorithms that when executed by the one or more processors cause the one or more processors to perform steps to initiate a connection to a first vehicle of the one or more vehicles, assume operational control of the first vehicle, and perform one or more assigned tasks and/or operational workflows for the first vehicle. The step of performing one or more assigned tasks and/or operational workflows for the first vehicle includes moving a first asset of the one or more assets in the one or more inventory management facilities from a first location in the one or more inventory management facilities to a second location in the one or more inventory management facilities.

For purposes of this disclosure, the one or more inventory management facilities includes, for example, one or more of a shipping yard, an industrial yard, a container terminal or yard, an intermodal yard, a container freight station, a warehouse, an order fulfillment facility, a depot, a distribution center, a logistics park or facility, a shop bay, a port, a terminal, a container ship, a railyard, a railroad classification yard, and one or more other distribution points downstream, or combinations thereof. In some examples, the one or more inventory management facilities includes an overall area of one or more exemplary inventory management facilities. In some examples, the one or more inventory management facilities includes one or more parts, segments, areas, zones, or regions of one or more exemplary inventory management facilities. In some examples, the one or more inventory management facilities includes combinations of an overall area of one or more exemplary inventory management facilities and one or more parts, segments, areas, zones, or regions of one or more other exemplary inventory management facilities. The one or more parts, segments, areas, zones, and/or regions of the one or more exemplary inventory management facilities includes, for example, one or more entry points (e.g., entry gates), one or more exit points (e.g., exit gates), one or more operating areas, one or more staging areas, one or more storage areas, one or more loading and/or unloading areas, and/or one or more maintenance areas, and/or other parts, segments, areas, zones, and/or regions of the one or more exemplary inventory management facilities of one or more of a shipping yard, an industrial yard, a container terminal or yard, an intermodal yard, a container freight station, a warehouse, an order fulfillment facility, a depot, a distribution center, a logistics park or facility, a shop bay, a port, a terminal, a container ship, a railyard, a railroad classification yard, and/or one or more other distribution points downstream, and/or combinations thereof. The one or more operating areas includes one or parts, segments, areas, zones, and/or regions of the one or more exemplary inventory management facilities where a vehicle is capable of being operated, one or more parts, segments, areas, zones, and/or regions (where a vehicle is capable of being operated) connecting one or more exemplary inventory management facilities, and/or one or more parts, segments, areas, zones, and/or regions (where a vehicle is capable of being operated) between one or more exemplary inventory management facilities.

For purposes of this disclosure, freight includes, for example, one or more goods capable of being transported by one or more assets. The invention is not limited to any particular good, or goods, being transported and includes, for example, any material (e.g., raw materials), merchandise, product, supply or supplies, component, device, automotive vehicle, equipment, machinery, food, clothing, electronics, furniture, palletized loads, fuels, gas, chemicals, ore, minerals, agricultural products, and/or any other physical object or objects that can be moved, and/or parts thereof, and/or one or more groups, collections, and/or bundles or combinations thereof. The goods can be transported individually, in bulk, and/or in combination with one or more other items, and can be supported, held, contained in, on, and/or coupled to one or more means for transporting or storing goods, such as a crate (e.g., wooden crate), box, packaging, and/or other device or structure for transporting or storing goods.

For purposes of this disclosure, an asset includes, for example, one or more of a container, intermodal container, trailer, terminal trailer, port trailer, bomb cart, semi-trailer, chassis, railcar, railcar container, boxcar, cargobeamer car, coil car, combine car, flatcar such as a container flatcar, schnable car, gondola car, Presflo car, Prestwin car, bulk cement wagon car, roll-block car, slate wagon car, stock car, tank car, tank wagon car or tanker, milk car, “Whale Belly” car, transporter wagon car, or well car, or combinations thereof, or any other equipment capable of, or configured for, transporting freight via one or more modes of transportation. The freight can be transported by the one or more assets in any way, such as on, within, housed, enclosed, coupled to, held, and/or supported by the one or more assets, among other ways.

For purposes of this disclosure, the one or more vehicles includes, for example, one or more of a ground vehicle, a yard truck, a truck, a semi, a hostler, a yard checker, a terminal tractor, a bobtail, a forklift, a pallet mover (e.g., pallet truck), a sideloader, a toploader, a Rubber Tired Gantry Crane (RTG), or a remote controlled locomotive, or combinations thereof.

In embodiments, the system and method safely and intelligently move one or more assets within or between one or more inventory management facilities using one or more vehicles.

In some examples, a vehicle is configured to be remotely operated, such as a teleoperated vehicle, for example, a teleoperated yard truck.

In some examples, a vehicle is partially automated or autonomous.

In embodiments, the system and method move one or more assets from a first location to a second location within an inventory management facility (i.e., within the same inventory management facility, or within or between one or more parts, segments, areas, zones, and/or regions thereof). Additionally, or alternatively, the system and method move one or more assets from a first location in a first inventory management facility to a second location in a second inventory management facility (e.g., intra facility moves). The embodiments are not limited to a single move from a first location to a second location and include one or more moves from one location to another location. For example, the system and method move one or more assets from a first location to one or more intermediate locations before arriving at another location. The one or more moves are performed by the same vehicle or by one or more different vehicles. The one or more moves are performed sequentially or spaced over time, for example, with one or more periods of non-movement between one or more movements.

In embodiments, the system and method are configured to operate one or more vehicles remotely and/or autonomously within one or more inventory management facilities or between inventory management facilities, or within parts, segments, areas, zones, and/or regions of one or more inventory management facilities. In some examples, the system and method are configured to operate one or more vehicles remotely and/or autonomously to perform one or more assigned tasks and/or operational workflows for the one or more vehicles. In embodiments, the system enables an operator (e.g., a human operator) to operate a vehicle, at least in part, by commands received from a control station that is remote from the vehicle.

In embodiments, the operator (e.g., human operator) is not required to be physically present on the vehicle. For example, the operator is not required to be onboard the vehicle, in a cab of the vehicle, or at the on-board controls of the vehicle, etc. In some examples, the operator is beyond-line-of-site of the vehicle either within the inventory management facility or outside of the inventory management facility. In some examples, the operator is physically located anywhere globally irrespective of the vehicle location. In embodiments, the system and method virtualize and extend control, or at least partial control, of one or more functions of a vehicle to a control station at one or more remote locations, such as a location away from the vehicle within the inventory management facility, in another inventory management facility, in a control station such as a centralized control station controlling one or more vehicles in one or more inventory management facilities, or anywhere globally.

In embodiments, the system and method enables an operator (e.g., a remote operator) to operate a vehicle remotely using video and/or audio integration, for example, via one or more communication methods, integrated client and server-side system/technologies, and/or other integrated technology solutions.

The embodiments enable the system to remotely operate one or more vehicles in the field with or without a local vehicle operator to move one or more assets from a first location (e.g., point a) to a second location (e.g., point b) within or between one or more inventory management facilities.

In the embodiments, a local human operator is not required to operate the vehicle (e.g., yard truck) from onboard the vehicle, such as within the vehicle's cab, thereby minimizing or avoiding the operator being exposed to local environmental conditions of the inventory management facility, such as high or low temperatures or humidity, inclement weather, etc. An individual operator is not required to be physically present or onboard each vehicle to operate the vehicle and perform a workflow within or between the inventory management facilities. In some examples, the individual remote operator is not required to be present or operate the vehicle throughout an entire workflow in or between the inventory management facilities, including during times during a workflow in which the vehicle is stationary, such as when the vehicle is parked, waiting in line with other vehicles, waiting in a queue with other vehicles, etc. for its turn to move or proceed from one location to another, to be attended to, to be loaded and/or unloaded with one or more assets, to be connected and/or disconnected with one or more assets, to be docked and/or moved from a dock, etc.

In embodiments, staffing multiple shifts of vehicle operators at a single inventory management facility may not be required to operate one or more vehicles in the inventory management facility throughout the hours of operation, including shifts during daylight and nighttime hours.

In embodiments, the system and method optimizes operation (e.g., teleoperated, partially teleoperated, and/or autonomous vehicle operation) of one or more vehicles in one or more inventory management facilities by one or more operators.

In embodiments, the system and method are configured to optimize vehicle operation (e.g., teleoperated, partially teleoperated, and/or autonomous vehicle operation) utilizing multiplexing (e.g., vehicle multiplexing, driver multiplexing, and/or task multiplexing).

In embodiments, the system and method utilize time zone differentials to optimize operation (e.g., teleoperated, partially teleoperated, and/or autonomous vehicle operation) of one or more vehicles, such as one or more yard trucks.

In embodiments, the system and method provide centralized operation of one or more inventory management facilities and/or one or more regions of inventory management facilities, and/or one or more vehicles of one or more inventory management facilities and/or one or more regions of one or more inventory management facilities.

In embodiments, the system and method are configured to facilitate and/or optimize gladhand connections for one or more vehicles (e.g., teleoperated, partially teleoperated, and/or autonomous vehicles).

In embodiments, the system and method provide intelligent queueing for one or more remotely operated vehicles.

In embodiments, the system and method provide intelligent task assignment and workflow optimization for one or more remotely operated vehicles.

In embodiments, the system and method provide mission management for one or more remote operations of vehicles.

In embodiments, the system and method provide remote operation features.

In embodiments, the system and method provide spatial situational awareness for one or more teleoperated and autonomous vehicle operations.

In embodiments, the system and method provide route planning for optimizing one or more teleoperated vehicle operations.

In embodiments, the system and method provide congestion forecasting for optimizing one or more teleoperated and autonomous vehicle operations.

In embodiments, the system and method provide system and method for avoiding areas in teleoperated and autonomous vehicle operations.

In embodiments, the system and method provide system and method for avoiding areas in poor communication for teleoperated and autonomous vehicle operations.

In embodiments, the system and method provide heads-up object classification for optimizing teleoperated vehicle operations.

In embodiments, the system and method provide for using ambient external audio.

In embodiments, the system and method provide feedback in remotely operated and autonomous vehicle operations.

In embodiments, the system and method provide for using automated queuing to enhance teleoperated vehicle operations.

In embodiments, the system and method provide intelligent vehicle operation that combines autonomous navigation with teleoperation.

In embodiments, the system and method provide for optimizing vehicle operations using automated trailer reversing with teleoperation.

In embodiments, the system and method provide for optimizing vehicle operations using automated trailer connecting with teleoperation.

In embodiments, the system and method provide haptic feedback for teleoperated and autonomous vehicle operations.

In embodiments, the system and method provide for user-tunable video stitching for teleoperated and autonomous vehicle operations.

In embodiments, the system and method provide guidelines for teleoperated and autonomous vehicle operations.

In embodiments, the system and method provide for determining alignment with lift equipment in teleoperated vehicle operations.

In embodiments, the system and method provide for tracking presence and alertness of one or more teleoperated vehicle operators.

In embodiments, the system and method provide for monitoring safe and efficient teleoperated driving.

In embodiments, the system and method provide remote site comms for one or more remotely operated vehicles.

In embodiments, the system and method provide for automatically changing one or more camera views based on situational context.

In embodiments, the system and method provide collision avoidance in teleoperated vehicle operations.

In embodiments, the system and method provide one or more visualizing sensor zones for improving teleoperated and autonomous vehicle operations.

### BRIEF DESCRIPTION OF THE DRAWINGS

These and other aspects and features of embodiments of the present invention will be better understood after a reading of the following detailed description, together with the attached drawings, wherein:

FIG. 1 is a diagram illustrating example layouts of inventory management facilities.

FIG. 2 is a schematic view of a system for remotely operating one or more vehicles in one or more inventory management facilities according to an exemplary embodiment of the invention.

FIG. 3 is a flowchart illustrating a remote support session of an operator console and vehicle according to an exemplary embodiment of the invention.

FIG. 4 is a flowchart illustrating a remote support session of a vehicle according to an exemplary embodiment of the invention.

FIG. 5 is a diagram illustrating example remote support sessions of a vehicle in an inventory management facility according to an exemplary embodiment of the invention.

FIG. 6 is a diagram illustrating example remote support sessions of a vehicle in an inventory management facility according to an exemplary embodiment of the invention.

FIG. 7 is a flowchart illustrating a remote support session of a vehicle according to an exemplary embodiment of the invention.

FIG. 8 is a flowchart illustrating a remote support session of a vehicle according to an exemplary embodiment of the invention.

FIG. 9 is a diagram illustrating example remote support sessions of a vehicle in an inventory management facility according to an exemplary embodiment of the invention.

FIG. 10 is a diagram illustrating a vehicle having an object detection sensor according to an exemplary embodiment of the invention.

FIG. 11 is a diagram illustrating a vehicle having a visualization system for viewing a vehicle path and/or a trailing path according to an exemplary embodiment of the invention.

FIG. 12 is a diagram illustrating a collision avoidance system according to an exemplary embodiment of the invention.

Other features and advantages of the present invention will become apparent to those skilled in the art upon review of the following detailed description and drawings. It should be understood that the drawings are not necessarily to scale and that the disclosed embodiments are sometimes illustrated diagrammatically and in partial views. In certain instances, details which are not necessary for an understanding of the disclosed methods and apparatuses, or which render other details difficult to perceive may have been omitted. It should be understood, of course, that this disclosure is not limited to the particular embodiments illustrated herein.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

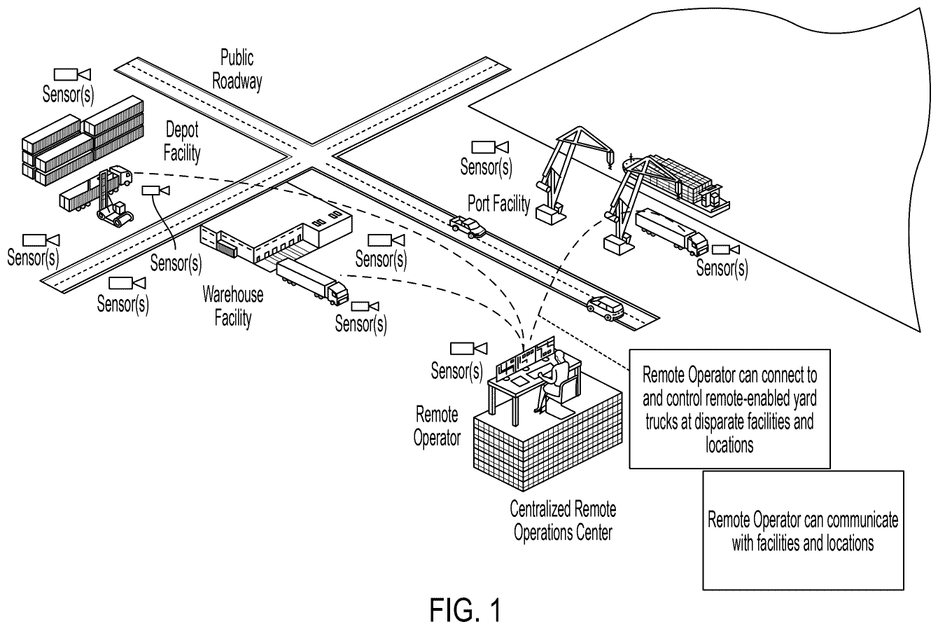

Referring now to the drawings, FIGS. 1-12 illustrate exemplary embodiments of a system for, and method of, remotely operating one or more vehicles in one or more inventory management facilities.

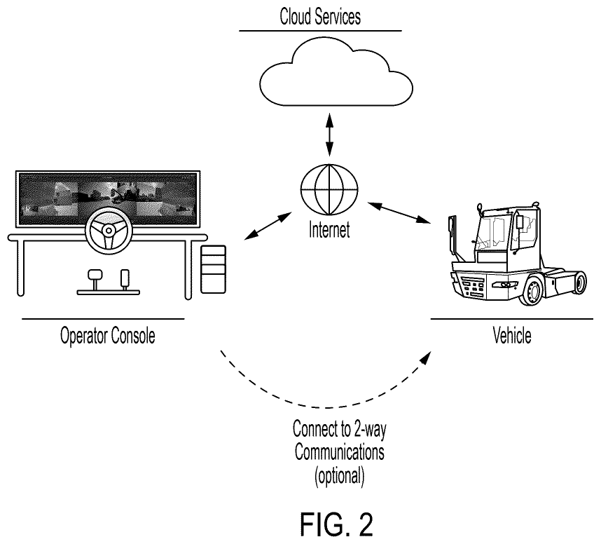

With reference to FIGS. 1-2, an exemplary embodiment of a system for, and method of, remotely operating one or more vehicles in one or more inventory management facilities, includes one or more vehicles configured to move one or more assets in one or more inventory management facilities from a first location to a second location, and a control station in communication with the one or more vehicles, wherein the control station is remote from the one or more vehicles and communicates at least one operational command to the one or more vehicles to operate the one or more vehicles to move the one or more assets in the one or more inventory management facilities from the first location to the second location. The control station includes a computer or server or a combination thereof including one or more processors and one or more non-transitory computer-readable storage mediums storing instructions comprising one or more algorithms that when executed by the one or more processors cause the one or more processors to perform steps. The control station includes, for example, an operator console (e.g., a remote operator/teleoperator workstation). The operator console includes, for example, a screen, display, or the like for conveying information to the operator. The operator console includes, for example, operation controls such as a steering wheel, accelerator, brake, transmission actuator, turn indicator actuator, or other operation controls, or combinations thereof for remotely operating one or more vehicles. One of ordinary skill in the art will recognize that other devices and/or controls may be provided or utilized for the operator to provide operational control of one or more vehicles, such as one or more computer devices, tablets, applications, controllers, gaming controllers, or combinations thereof.

In embodiments, one or more computers and/or servers or combinations thereof, one or more vehicles, and one or more control stations may be communicatively coupled via a network. The network may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc.

A server may be configured to perform automated analysis of the data collected as part of the operation workflow. In embodiments, the automated analysis of the data may include ingesting the data and generating an output including results of the automated analysis, in accordance with embodiments of the present disclosure. This functionality of server may be provided by the cooperative operation of the various components of a server (e.g., one or more servers). It will be appreciated that the server and its individual functional blocks may be implemented as a single device or may be distributed over multiple devices having their own processing resources, whose aggregate functionality may be configured to perform operations in accordance with the present disclosure. Furthermore, those of skill in the art would recognize that each of the various components of the server may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of the server may be part of a different component of the server, and as such, the description of the particular functionality described for the particular component of the server is for illustrative purposes and not limiting in any way.

A server includes one or more processors, memory, databases, and/or I/O modules. The one or more processors may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In embodiments, implementations of the one or more processors may comprise code segments (e.g., software, firmware, and/or hardware logic) executable in hardware, such as a processor, to perform the tasks and functions described herein. In embodiments, the one or more processors may be implemented as a combination of hardware and software. The one or more processors may be communicatively coupled to one or more memory, memory devices, and/or memory services. The memory may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. The memory may comprise a processor readable medium configured to store one or more instruction sets (e.g., software, firmware, etc.) which, when executed by a processor (e.g., one or more processors), perform tasks and functions as described herein. The memory may also be configured to facilitate storage operations. For example, the memory may comprise a database for storing various information related to operations of system. For example, database may store ML models, mathematical models, rules models, and/or other models that may be used by components of server to analyze and process data in accordance with embodiments of the present disclosure. In embodiments, the database may be integrated into the memory or the database may be provided as a separate storage module or may be provided as a cloud-based storage module, as shown in FIG. 2. Additionally, or alternatively, the database may be a single database, or may be a distributed database implemented over a plurality of database modules. An I/O module may be configured to perform input and/or output operations for the server as part of the operational workflow described herein and performed in accordance with the present disclosure. In embodiments, input functionality of an I/O module may include an automated data ingestion module configured to automatically ingest, retrieve, collect, download, or otherwise receive the data collected in accordance with embodiments of the present disclosure. In embodiments, an I/O module may establish a connection with one or more vehicles and/or one or more sensors or combinations thereof (e.g., via a network or another communication network), and may ingest data therefrom, either by retrieving the data from the onboard memory thereof or by receiving a live stream of the data therefrom. In embodiments, output functionality of an I/O module may include generation and outputting of results in accordance with embodiments of the present disclosure. In embodiments, an I/O module may be configured to provide the results to the control station for presentation to a remote operator (e.g., via a GUI displayed on an operator console).

These components, and their individual components, may cooperatively operate to provide functionality in accordance with the discussion herein. For example, in operation, the control station may facilitate a user (e.g., a remote operator) interacting with the system, e.g., via a network, to initiate a connection to a vehicle (such as a yard truck) and assume operational control of the vehicle to perform one or more assigned tasks and/or operational workflows for the vehicle (e.g., a teleoperation session and/or remote support session). In embodiments, the system may facilitate a remote operator terminating, at least temporarily, a connection to a first vehicle and then initiating a connection to a second vehicle and assuming operational control of the second vehicle to perform one or more assigned tasks and/or operational workflows for the second vehicle. In embodiments, the system may facilitate the remote operator, or a different remote operator, initiating a new connection to a first vehicle and then assuming operational control of the first vehicle to perform one or more additional assigned tasks and/or operational workflows for the first vehicle.

In embodiments, the system and method safely and intelligently move one or more assets within or between one or more inventory management facilities using one or more vehicles. In some embodiments, the one or more vehicles are configured to be remotely operated, such as a teleoperated vehicle, for example, a teleoperated yard truck. In some embodiments, the one or more vehicles are partially automated or autonomous.

In some embodiments, the system and method move one or more assets from a first location to a second location within an inventory management facility. Additionally, or alternatively, the system and method move one or more assets from a first location in a first inventory management facility to a second location in a second inventory management facility (e.g., intra facility moves).

In embodiments, the system and method are configured to operate one or more vehicles remotely and/or autonomously within one or more inventory management facilities or between inventory management facilities, or within one or more parts, segments, areas, zones, or regions of one or more inventory management facilities. In examples, the system and method are configured to operate one or more vehicles remotely and/or autonomously to perform one or more assigned tasks and/or operational workflows for the one or more vehicles.

In embodiments, the system enables an operator (e.g., a human operator) to operate a vehicle, at least in part, by commands received from a control station that is remote from the vehicle.

In embodiments, the operator (e.g., human operator) is not physically present on the vehicle. For example, the operator is not onboard the vehicle, not in a cab of the vehicle, or not at the on-board controls of the vehicle, etc. In embodiments, the operator is beyond-line-of-site of the vehicle, for example, in the same inventory management facility, or one or more parts, segments, areas, zones, or regions thereof, of the vehicle or a different inventory management facility from the vehicle. In embodiments, the operator is physically located anywhere globally irrespective of the vehicle location.

In embodiments, the system and method virtualize and extend control, or at least partial control, of one or more functions of a vehicle to a control station at one or more remote locations, such as a location away from the vehicle within the inventory management facility, in another inventory management facility, in a control station such as a centralized control station controlling one or more vehicles in one or more inventory management facilities, or anywhere globally.

In embodiments, the system and method enables an operator (e.g., a remote operator) to operate a vehicle remotely using video and/or audio integration, for example, via one or more communication methods, integrated client and server-side system/technologies, and/or other integrated technology solutions.

The embodiments enable the system to remotely operate one or more vehicles in the field with or without a local vehicle operator to move one or more assets from a first location (e.g., point a) to a second location (e.g., point b) within or between one or more inventory management facilities.

In embodiments, the system and method optimize operation (e.g., teleoperated, partially teleoperated, and/or autonomous vehicle operation) of one or more vehicles in one or more inventory management facilities by one or more operators.

With reference again to FIGS. 1-12, exemplary embodiments of a system for, and method of, optimizing remote operation of one or more vehicles in one or more inventory management facilities, will now be described.

FIG. 1 illustrates various example layouts or configurations of one or more exemplary inventory management facilities. The one or more inventory management facilities are not limited to any particular type of inventory management facility and includes, for example, one or more of a shipping yard, an industrial yard, a container terminal or yard, an intermodal yard, a container freight station, a warehouse, an order fulfillment facility, a depot, a distribution center, a logistics park or facility, a shop bay, a port, a terminal, a container ship, a railyard, a railroad classification yard, and one or more other distribution points downstream, or combinations thereof. In some examples, the one or more inventory management facilities includes an overall area of one or more exemplary inventory management facilities. In some examples, the one or more inventory management facilities includes one or more parts, segments, areas, zones, or regions of one or more exemplary inventory management facilities. In some examples, the one or more inventory management facilities includes combinations of an overall area of one or more exemplary inventory management facilities and one or more parts, segments, areas, zones, or regions of one or more other exemplary inventory management facilities. The one or more parts, segments, areas, zones, and/or regions of the one or more exemplary inventory management facilities includes, for example, one or more entry points (e.g., entry gates), one or more exit points (e.g., exit gates), one or more operating areas, one or more staging areas, one or more storage areas, one or more loading and/or unloading areas, and/or one or more maintenance areas, and/or other parts, segments, areas, zones, and/or regions of the one or more exemplary inventory management facilities of one or more of a shipping yard, an industrial yard, a container terminal or yard, an intermodal yard, a container freight station, a warehouse, an order fulfillment facility, a depot, a distribution center, a logistics park or facility, a shop bay, a port, a terminal, a container ship, a railyard, a railroad classification yard, and/or one or more other distribution points downstream, and/or combinations thereof. The one or more operating areas includes one or parts, segments, areas, zones, and/or regions of the one or more exemplary inventory management facilities where a vehicle is capable of being operated, one or more parts, segments, areas, zones, and/or regions (where a vehicle is capable of being operated) connecting one or more exemplary inventory management facilities, and/or one or more parts, segments, areas, zones, and/or regions (where a vehicle is capable of being operated) between one or more exemplary inventory management facilities.

The one or more inventory management facilities are configured to store, move, transport, load, and/or unload freight including, for example, one or more goods capable of being transported by one or more assets. The exemplary embodiment is not limited to any particular good, or goods, being transported and includes, for example, any material (e.g., raw materials), merchandise, product, supply or supplies, component, device, automotive vehicle, equipment, machinery, food, clothing, electronics, furniture, palletized loads, fuels, gas, chemicals, ore, minerals, agricultural products, and/or any other physical object or objects that can be moved, and/or parts thereof, and/or one or more groups, collections, and/or bundles or combinations thereof. The goods can be transported individually, in bulk, and/or in combination with one or more other items, and can be supported, held, contained in, on, and/or coupled to one or more means for transporting or storing goods, such as a crate (e.g., wooden crate), box, packaging, and/or other device or structure for transporting or storing goods.

As shown in the examples illustrated, one or more assets is provided in the one or more inventory management facilities. The exemplary embodiment is not limited to any particular asset or assets, and includes, for example, one or more of a container, intermodal container, trailer, terminal trailer, port trailer, bomb cart, semi-trailer, chassis, railcar, railcar container, boxcar, cargobeamer car, coil car, combine car, flatcar such as a container flatcar, schnable car, gondola car, Presflo car, Prestwin car, bulk cement wagon car, roll-block car, slate wagon car, stock car, tank car, tank wagon car or tanker, milk car, “Whale Belly” car, transporter wagon car, or well car, or combinations thereof, or any other equipment capable of, or configured for, transporting freight via one or more modes of transportation. The freight can be transported by the one or more assets in any way, such as on, within, housed, enclosed, coupled to, held, and/or supported by the one or more assets, among other ways.

As shown in the examples illustrated, one or more vehicles are provided and/or operated in the one or more inventory management facilities. The exemplary embodiment is not limited to any particular vehicle or vehicles, and includes, for example, one or more of a ground vehicle, a yard truck, a truck, a semi, a hostler, a yard checker, a terminal tractor, a bobtail, a forklift, a pallet mover (e.g., pallet truck), a sideloader, a toploader, a Rubber Tired Gantry Crane (RTG), or a remote controlled locomotive, or combinations thereof.

As shown in the examples illustrated, a system and method safely and intelligently move one or more assets within or between one or more inventory management facilities using one or more vehicles. In some examples, a vehicle is configured to be remotely operated, such as a teleoperated vehicle, for example, a teleoperated yard truck. In some examples, a vehicle is partially automated or autonomous.

In embodiments, the system and method move one or more assets from a first location to a second location within an inventory management facility (i.e., within the same inventory management facility, or within or between one or more parts, segments, areas, zones, and/or regions thereof). Additionally, or alternatively, the system and method move one or more assets from a first location in a first inventory management facility to a second location in a second inventory management facility (e.g., intra facility moves). The embodiments are not limited to a single move from a first location to a second location and include one or more moves from one location to another location. For example, the system and method move one or more assets from a first location to one or more intermediate locations before arriving at another location. The one or more moves are performed by the same vehicle or by one or more different vehicles. The one or more moves are performed sequentially or spaced over time, for example, with one or more periods of non-movement between one or more movements.

As schematically illustrated in the example of FIG. 1, the system and method are configured to operate one or more vehicles remotely and/or autonomously within one or more inventory management facilities or between inventory management facilities, or within parts, segments, areas, zones, and/or regions of one or more inventory management facilities. In some examples, the system and method are configured to operate one or more vehicles remotely and/or autonomously to perform one or more assigned tasks and/or operational workflows for the one or more vehicles. In embodiments, the system enables an operator (e.g., a human operator, such as a remote operator) to operate a vehicle, at least in part, by commands received from a control station that is remote from the vehicle.

In examples, the operator (e.g., human operator) is not required to be physically present on the vehicle. For example, the operator is not required to be onboard the vehicle, in a cab of the vehicle, or at the on-board controls of the vehicle, etc. In some examples, the operator is beyond-line-of-site of the vehicle either within the inventory management facility or outside of the inventory management facility. In some examples, the operator is physically located anywhere globally irrespective of the vehicle location. In examples, the system and method virtualize and extend control, or at least partial control, of one or more functions of a vehicle to a control station at one or more remote locations, such as a location away from the vehicle within the inventory management facility, in another inventory management facility, in a control station such as a centralized control station controlling one or more vehicles in one or more inventory management facilities, or anywhere globally.

In examples, the system and method enables an operator (e.g., a remote operator) to operate a vehicle remotely using video and/or audio integration, for example, via one or more communication methods, integrated client and server-side system/technologies, and/or other integrated technology solutions. The embodiments enable the system to remotely operate one or more vehicles in the field with or without a local vehicle operator to move one or more assets from a first location (e.g., point a) to a second location (e.g., point b) within or between one or more inventory management facilities.

In examples, a local human operator is not required to operate the vehicle (e.g., yard truck) from onboard the vehicle, such as within the vehicle's cab, thereby minimizing or avoiding the operator being exposed to local environmental conditions of the inventory management facility, such as high or low temperatures or humidity, inclement weather, etc. An individual operator is not required to be physically present or onboard each vehicle to operate the vehicle and perform a workflow within or between the inventory management facilities. In some examples, the individual remote operator is not required to be present or operate the vehicle throughout an entire workflow in or between the inventory management facilities, including during times during a workflow in which the vehicle is stationary, such as when the vehicle is parked, waiting in line with other vehicles, waiting in a queue with other vehicles, etc. for its turn to move or proceed from one location to another, to be attended to, to be loaded and/or unloaded with one or more assets, to be connected and/or disconnected with one or more assets, to be docked and/or moved from a dock, etc.

In the illustrated examples, one or more inventory management facilities, and/or parts, segments, areas, zones, or regions thereof, includes one or more communications systems such as one or more of a 2-way radio communications system, a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc.

In the illustrated examples, one or more inventory management facilities, or parts, segments, areas, zones, or regions thereof, includes one or more sensors.

In some examples, the one or more sensors are provided in fixed positions in one or more inventory management facilities, and/or in one or more parts, segments, areas, zones, or regions thereof. For example, one or more sensors are fixed to one or more poles, buildings, structures, and/or objects having a fixed position in one or more inventory management facilities, and/or in one or more parts, segments, areas, zones, or regions thereof (e.g., randomly positioned throughout, spaced throughout, positioned in a grid pattern throughout, etc.). In some examples, one or more sensors are configured to focus on a fixed part, segment, area, zone, or region of an inventory management facility, such as a fixed location camera. In some examples, one or more sensors are configured to be movable to focus on one or more parts, segments, areas, zones, or regions of an inventory management facility, such as one or more pan-tilt-zoom (PTZ) cameras configured to swivel (e.g., left and/or right), tilt (e.g., up and/or down), and/or zoom (e.g., in and/or out).

In some examples, the system and method are configured such that one or more vehicles (e.g., yard trucks) include one or more sensors. As the one or more vehicles drive through the facility environment of the one or more inventory management facilities, the one or more sensors generate sensor data. In some examples, the one or more sensors includes, for example, one or more cameras (e.g., used for remote driving) such as one or more cameras mounted on the vehicle (e.g., used for remote driving). The one or more sensors includes, for example, one or more inertial measurement units (IMU's) and/or one or more cameras (e.g., used for remote driving).

In some examples, the one or more sensors includes, for example, one or more sensors for detecting vibration, impact, velocity, acceleration, position, proximity, etc., among other metrics or characteristics of one or more vehicles, assets, humans, or other objects. In some examples, one or more sensors are provided on a vehicle to monitor operation of the vehicle, such as harsh braking, harsh turning, and/or other operating metrics data of the vehicle. In some examples, the one or more vehicles includes one or more sensors or sets of sensors on the vehicle, such as one or more object detection sensors, for example, radar and/or lidar, etc.

In some examples, the system and method include one or more audio sensors, such as microphones and/or transducers located onboard the vehicle and configured to transmit audio sensor data to the operator console.

In some examples, the system and method include one or more sensors, such as one or more cameras, at one or more control stations, such as on the operator console of one or more control stations. For example, one or more cameras face an operator using the operator console to remotely control one or more vehicles in one or more inventory management facilities.

FIG. 2 schematically illustrates exemplary components of a system for remotely operating one or more vehicles in one or more inventory management facilities according to an exemplary embodiment of the invention.

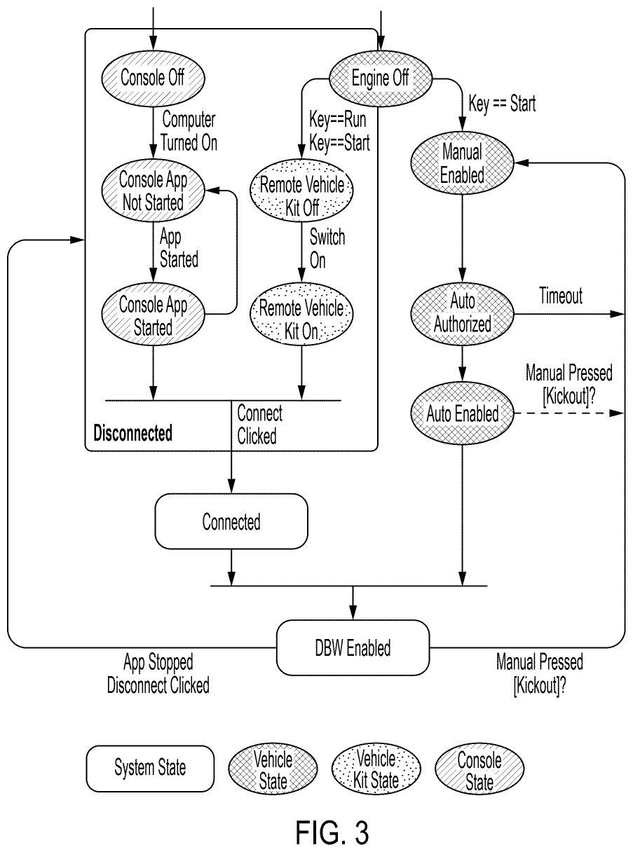

FIG. 3 illustrates an exemplary flowchart and state diagram illustrating a remote support session of an operator console and vehicle according to an exemplary embodiment of the invention.

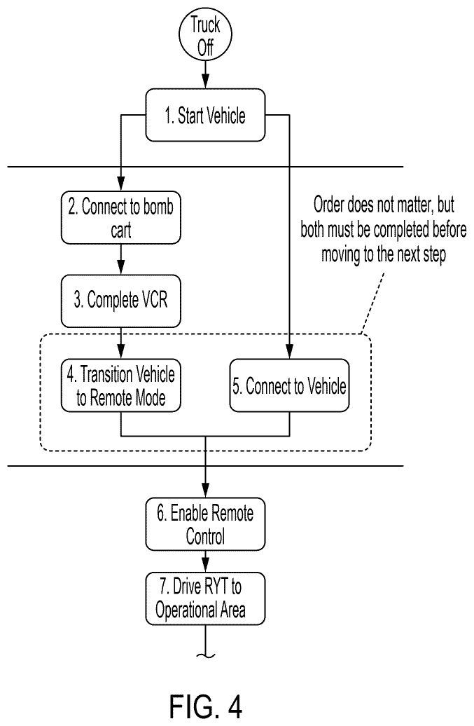

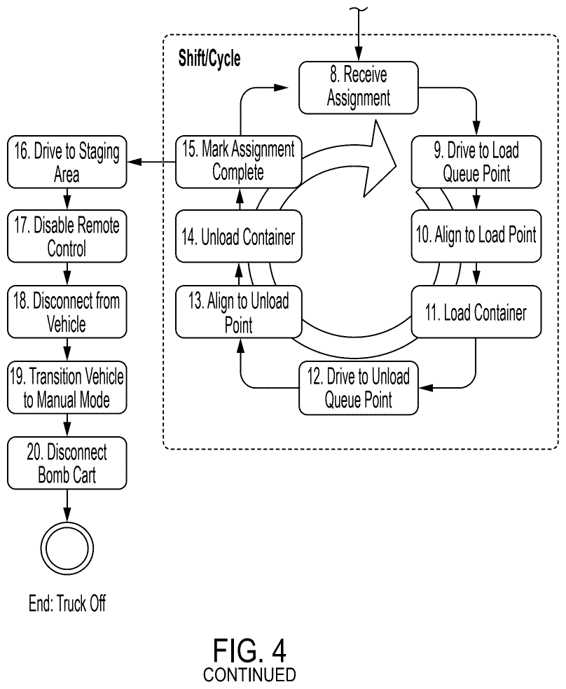

FIG. 4 is a flowchart illustrating a remote support session and workflow of a vehicle moving an asset, such as a bomb cart, according to an exemplary embodiment of the invention.

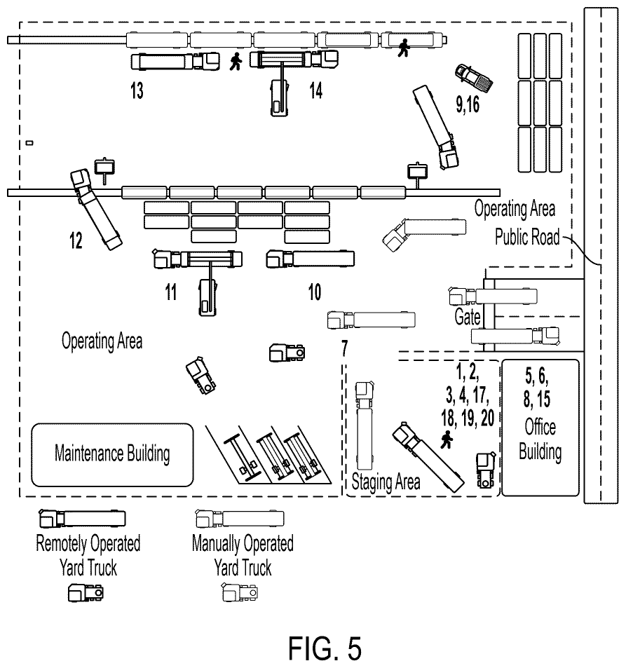

FIG. 5 is a diagram illustrating example remote support sessions of a vehicle in an inventory management facility, such as a rail terminal, according to an exemplary embodiment of the invention.

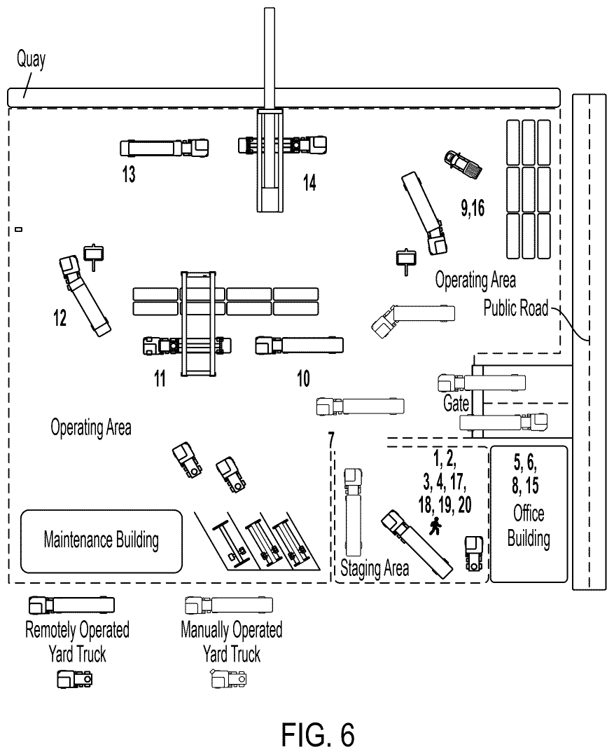

FIG. 6 is a diagram illustrating example remote support sessions of a vehicle in an inventory management facility, such as a port, according to an exemplary embodiment of the invention.

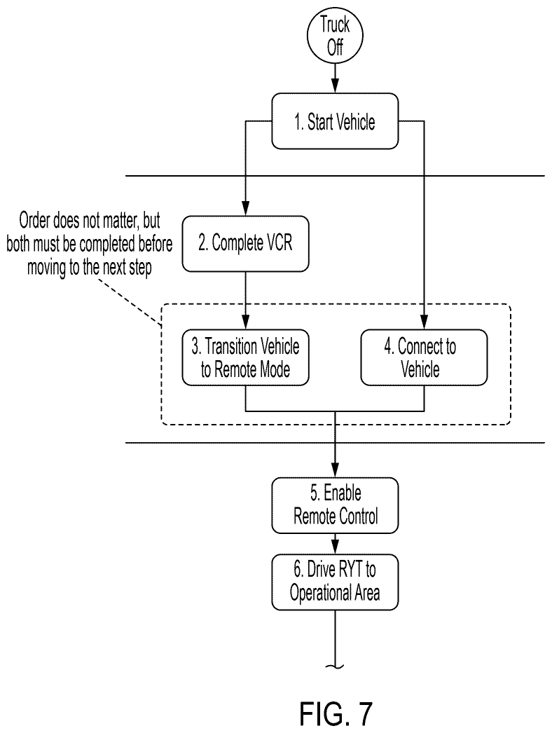

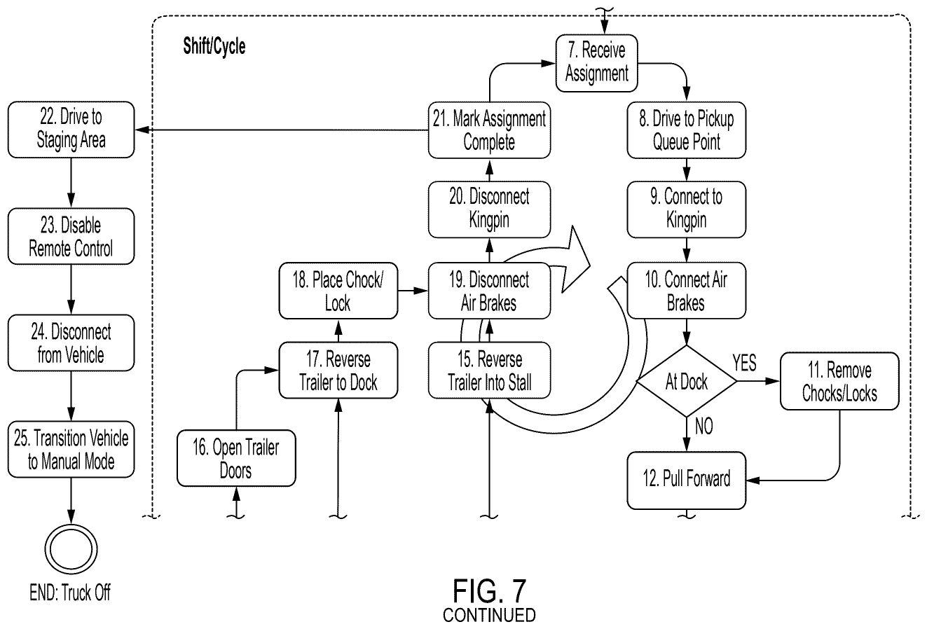

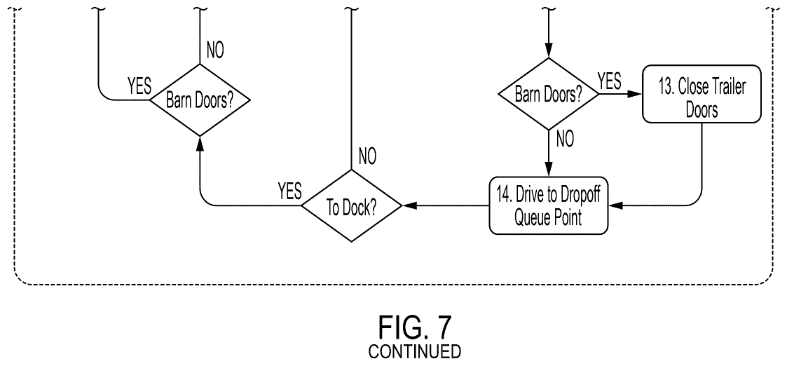

FIG. 7 is a flowchart illustrating a remote support session and workflow of a vehicle in an inventory management facility, such as a warehouse facility, according to an exemplary embodiment of the invention.

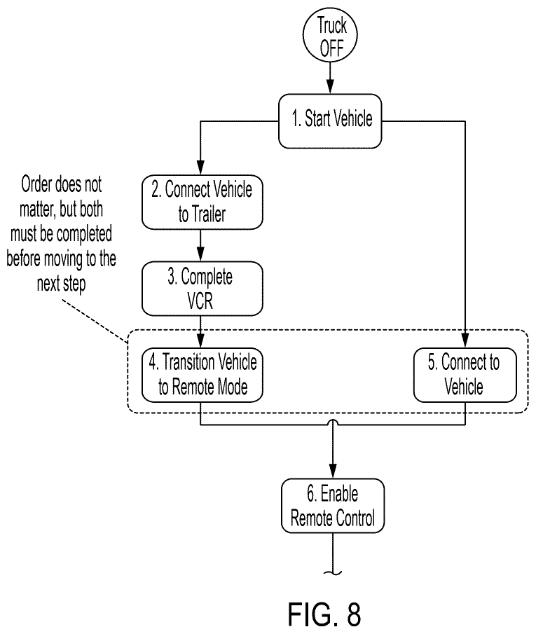

FIG. 8 is a flowchart illustrating a remote support session and workflow of a vehicle in an inventory management facility, such as an order fulfillment facility, according to an exemplary embodiment of the invention.

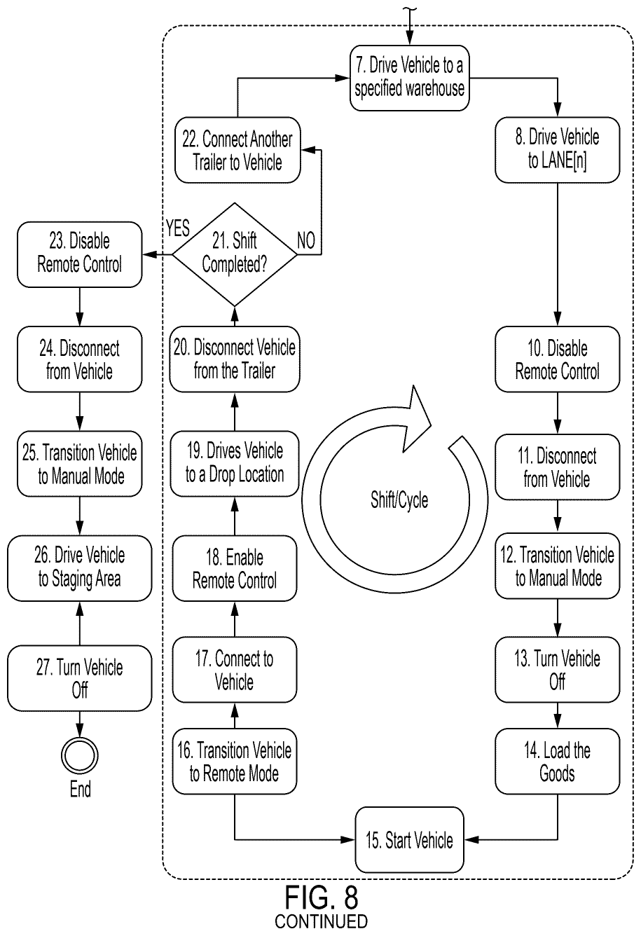

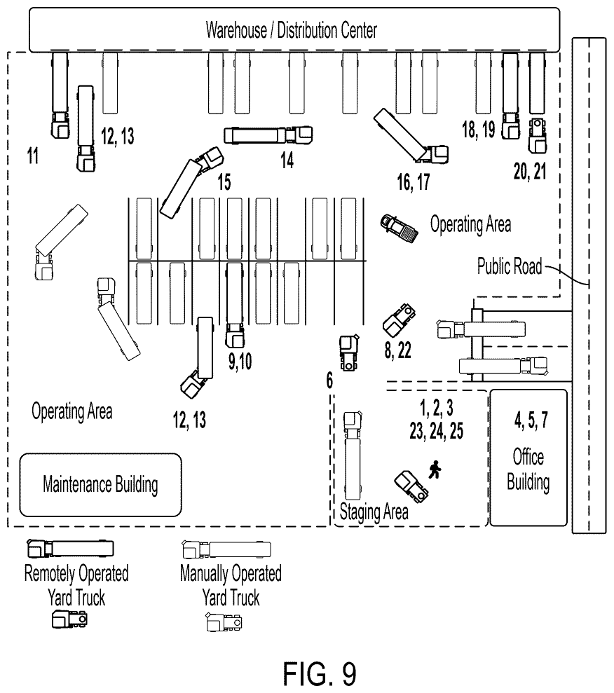

FIG. 9 is a diagram illustrating example remote support sessions of a vehicle in an inventory management facility, such as a warehouse facility, according to an exemplary embodiment of the invention.

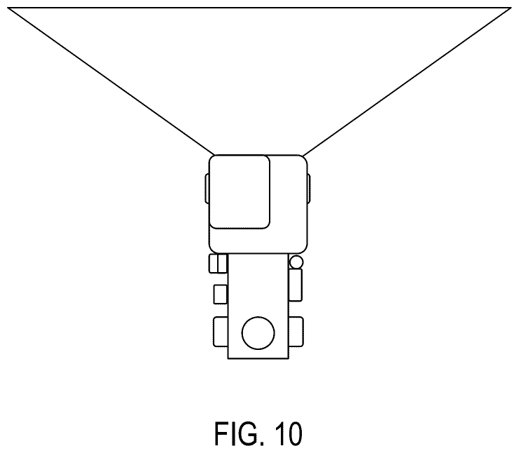

FIG. 10 is a diagram illustrating a sensor overlay of a vehicle having an object detection sensor according to an exemplary embodiment of the invention.

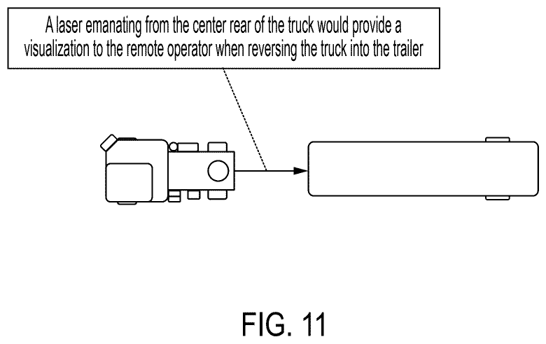

FIG. 11 is a diagram illustrating a vehicle having a visualization system for providing visual cues for viewing a vehicle path and/or a trailing path according to an exemplary embodiment of the invention.

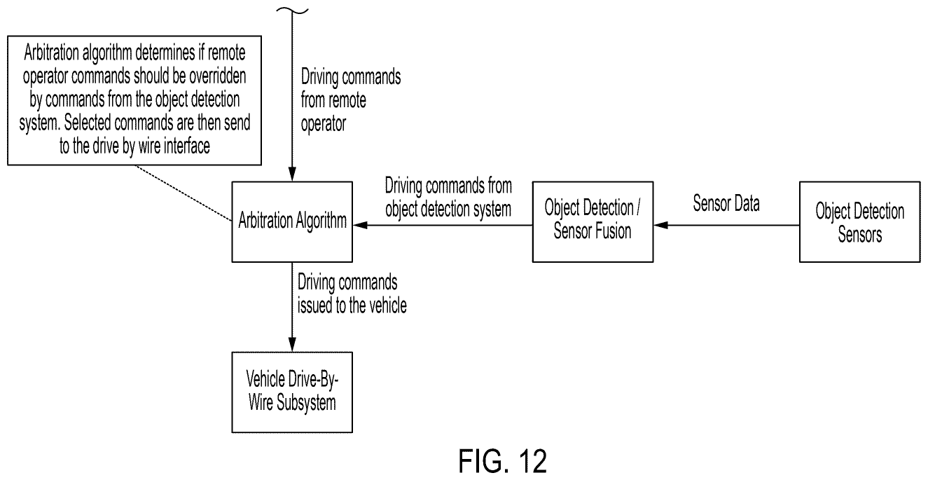

FIG. 12 is a diagram illustrating a collision avoidance system according to an exemplary embodiment of the invention.

### Multiplexing to Optimize Vehicle Operations

In embodiments, the system and method are configured to optimize vehicle operation (e.g., teleoperated, partially teleoperated, and/or autonomous vehicle operation) utilizing multiplexing (e.g., vehicle multiplexing, driver multiplexing, and/or task multiplexing). For example, in embodiments, the system and method enables a single remote operator to multiplex or multitask across different vehicles, such as different yard trucks, and/or different inventory management facilities or parts thereof, for example, during a single shift of a work schedule. For example, the remote operator may perform tasks using a first vehicle in an inventory management facility in California for a first part of the operator's shift, then perform tasks using a second vehicle in an inventory management facility in Florida for a second half of the operator's shift. In examples, the remote operator may perform tasks using a first vehicle in an inventory management facility for a first part of the operator's shift, then perform tasks using a second vehicle in the inventory management facility for a second half of the operator's shift. In examples, the remote operator may perform tasks using any number of vehicles in any number of facilities throughout any part of the operator's shift depending on the application or workflow. For example, the remote operator may frequently change or switch between a plurality of vehicles to perform one or more tasks in the same or different facilities throughout any part of the operator's shift (e.g., within a given hour or time period of the operator's shift). In embodiments, the system and methods enables a single vehicle in an inventory management facility to be operated (e.g., teleoperated, partially teleoperated, etc.) by multiple operators from one or more control stations.

### Time Zone Differentials to Optimize Vehicle Operations

In embodiments, the system and method utilize time zone differentials to optimize operation (e.g., teleoperated, partially teleoperated, and/or autonomous vehicle operation) of one or more vehicles, such as one or more yard trucks. In embodiments, the system and method enables one or more remote operators to be located anywhere in the world such that one or more vehicles at the facility is operated by a remote operator who is currently working a particular shift irrespective of the work shift at the location where the vehicle is located. For example, for a facility that operates 24/7 (i.e., 24 hours a day, seven days a week), the system and method enables one or more remote operators to be located anywhere in the world such that one or more vehicles at a facility that is on a night shift are operated by a remote operator who is currently working a day shift elsewhere in the world. In this way, the system and method more efficiently utilize operators, maximize or ensure operator availability, and/or minimize or avoid overtime costs, etc.

### Centralized Operation of One or More Inventory Management Facilities

In embodiments, the system and method provide centralized operation of one or more inventory management facilities and/or one or more regions of inventory management facilities. For example, the system and method include a centralized operations centers where one or more vehicles (e.g., one or more yard trucks, or all vehicles, such as all yard trucks) within one or more inventory management facilities or within a predetermined geographical region are operated from a centralized operations center or regional operators center.

### Optimizing Gladhand Connections for a Vehicle

In embodiments, the system and method are configured to facilitate and/or optimize gladhand connections for one or more vehicles (e.g., teleoperated, partially teleoperated, and/or autonomous vehicles). In conventional systems, the onboard driver of a vehicle (e.g., manual yard truck driver) exits the cab of the vehicle after connecting to an asset such as a trailer and manually connects the air hose for the trailer brakes and the electrical cable for the trailer lights. The present invention recognizes that, in the embodiments, the operator is not on the vehicle (and may not be physically present at the facility). To solve these and other problems, in embodiments, the system and method are configured to utilize one or more runners (e.g., human runner or runners) to connect gladhands within an inventory management facility. For example, a human runner can drive another vehicle, such as a golf cart, through all or one or more parts, segments, areas, zones, or regions of the facility and make airline and/or electrical connections for one or more vehicles being remotely operated or partially remotely operated within the facility.

### Intelligent Queueing for Remotely Operated Vehicles

The present invention recognizes that, in some applications/workflows, a vehicle, such as a yard truck, in an inventory management facility may spend a significant amount of time idle or queuing (e.g., waiting in line). In embodiments, the system and method enables a remote operator to position a first vehicle (e.g., yard truck A) in a queue. The remote operator then can disconnect from the first vehicle (e.g., cease, at least temporarily, from operating yard truck A) and connect to a second vehicle (e.g., yard truck B) in the same or a different inventory management facility to begin performing a task or workflow by operating the second vehicle (e.g., yard truck B). In embodiments, the system and method notifies the remote operator, or another remote operator (i.e., a different remote operator), when the first vehicle is ready to advance in the queue. The notified remote operator can connect to the first vehicle (e.g., yard truck A) and operate the first vehicle to advance the first vehicle in the queue. In embodiments of the system and method, the first vehicle are configured to autonomously advance (e.g., drive or move) in the queue. In embodiments, the system and method notifies the remote operator, or another remote operator, when the first vehicle has reached the end of the queue. The notified remote operator then can connect to the first vehicle (e.g., yard truck A) and perform the assigned workflow for the first vehicle.

### Intelligent Task Assignment and Workflow Optimization for Remotely Operated Vehicles

The system for, and method of, remotely operating a vehicle, such as a yard truck, in an inventory management facility, according to the embodiments, de-couples a particular operator from a particular vehicle. That is, a 1:1 ratio of an operator to a vehicle is no longer required. In embodiments, the system for, and method of, remotely operating one or more vehicles in one or more inventory management facilities are configured to optimize the utilization of one or more operators for operating one or more remote vehicles in one or more inventory management facilities. That is, for a given facility, or multiple facilities, in which one or more remote vehicles are operated, the embodiments optimize one or more operational parameters such as which operator or operators operate which remote vehicles, when and/or where such operator or operators operate such vehicles, or other parameters.

In embodiments, the system and method employ an algorithm (i.e., “Optimization Algorithm”). For example, in operation, the system is configured to receive a list of tasks (e.g., trailer moves, etc.) to be performed by a remotely operated vehicle at a given facility or multiple facilities. Ordinarily, this list is not prioritized and represents the list of all work (e.g., tasks, workflow, etc.) that must be completed. In embodiments, the system and method employ an Optimization Algorithm that considers one or more operational parameters including, for example, data related to which remotely operated vehicle or vehicles are available for work, data related to which remote operator or operators are available for work, data related to authorization rights, data related to proximity of available remotely operated vehicle(s) to the area in which work is needed, data related to timing requirements of the tasks to be completed, or combinations thereof, among other things. Based on the one or more operational parameters considered, the Optimization Algorithm is configured to pair one or more available remotely operated vehicles with one or more available remote operators. For example, the Optimization Algorithm is configured to pair an available remotely operated vehicle in proximity to the area in which work is needed with an available remote operator.

One of ordinary skill in the art will recognize that the system and method optimize operation of one or more vehicles in one or more inventory management facilities by one or more operators utilizing one or more of the aforementioned embodiments or combinations thereof. For example, the Optimization Algorithm is configured to pair an available remotely operated vehicle in proximity to the area in which work is needed with an available remote operator who is currently working a day shift.

### Mission Management for Remote Operations

The present invention recognizes that, in a manually operated environment, an assignment/mission such as moving a trailer from a first location (i.e., point A) to a second location (i.e., point B) is considered an atomic assignment. In a teleoperated scenario according to the embodiments, one or more different tasks within an overall mission/assignment may be assigned to one or more different remote operators throughout the mission lifecycle. In embodiments, the system and method employ a mission manager algorithm to at least one of track, assign, and/or monitor the individual tasks within an overall mission and determine, for example, when the overall mission/assignment is completed and/or if exceptions have occurred, among other things. According to the embodiments, the system and method optimize operation (e.g., teleoperated, partially teleoperated, and/or autonomous vehicle operation) of one or more vehicles in one or more inventory management facilities by one or more operators utilizing one or more criteria and/or one or more optimization algorithms, among other things. One of ordinary skill in the art will recognize that the system and method is not limited to any particular embodiment described herein. The system and method optimize operation of one or more vehicles in one or more inventory management facilities by one or more operators utilizing one or more of the embodiments described herein, various combinations thereof, or various combinations of parts thereof.

### Remote Operation Features

With reference again to FIGS. 1-12, exemplary embodiments of a system for, and method of, remotely operating one or more vehicles in one or more inventory management facilities, will now be described.

### Spatial Situational Awareness for Teleoperated and Autonomous Vehicle Operations

In embodiments, the system for, and method of, remotely operating one or more vehicles, such as a yard truck, in one or more inventory management facilities, includes a control station in communication with the one or more vehicles. The control station includes, for example, an operator console. The control station includes a computer or server including one or more processors and one or more non-transitory computer-readable storage mediums storing instructions comprising one or more algorithms that when executed by the one or more processors cause the one or more processors to perform steps. The operator console includes a screen, display, or the like for conveying information to the operator. In embodiments, the operator console displays to the remote operator a map view that shows geo-spatial information relative to the assigned tasks. This provided additional situational awareness for the remote operator. For example, the map view might display one or more vehicles, a pickup location, and/or a drop-off location. The vehicle location is updated as the vehicle moves through the environment (e.g., through one or more inventory management facilities). In embodiments, the operator console displays other information to the remote operator.

### Route Planning for Optimizing Teleoperated Vehicle Operations

In embodiments, the system and method include a route planning algorithm. The system and method are configured such that, when the remote operator is assigned a task and/or workflow to move one or more assets (e.g., one or more containers or trailers) from a first location (e.g., point A) to a second location (e.g., point B), the operator console determines, via the route planning algorithm, one or more routes that the remote operator may follow to drive between navigation/destination locations (e.g., the first location and the second location) and display the determined routes to the remote operator. In embodiments, the operator console suggests one or more preferred routes that the remote operator may follow to drive between the first location and the second location and display the suggested route or routes to the remote operator.

### Congestion Forecasting for Optimizing Teleoperated and Autonomous Vehicle Operations

In embodiments, the system and method are configured such that one or more vehicles (e.g., yard trucks) include one or more sensors. As the one or more vehicles drive through the facility environment of the one or more inventory management facilities, the one or more sensors generate sensor data. The one or more sensors include, for example, one or more cameras (e.g., used for remote driving). In embodiments, the system and method are configured such that a computer algorithm uses the sensor data to identify vehicles at one or more inventory management facilities. Based on the sensor data, the system and method are configured to identify, estimate, and/or forecast congestion within or between one or more inventory management facilities. In embodiments, the system and method are configured such that the operator console displays congestion information to the remote operator on the map view that shows geo-spatial information relative to the assigned tasks such that the remote operator uses this information to avoid areas of high congestion.

### System and Method for Avoiding Areas in Teleoperated and Autonomous Vehicle Operations

In embodiments, the system and method are configured such that one or more vehicles (e.g., yard trucks) include one or more sensors. As the one or more vehicles drive through the facility environment of the one or more inventory management facilities, the one or more sensors generate sensor data. The one or more sensors include, for example, one or more inertial measurement units (IMU's) and/or one or more cameras (e.g., used for remote driving). In embodiments, the system and method are configured such that a computer algorithm uses the sensor data to identify road conditions, for example, dynamic road/terrain features, such as rough road segments, rough terrain, etc., of one or more inventory management facilities. In embodiments, the system and method are configured such that the operator console displays the road condition information to the remote operator on the map view such that the remote operator may use this information to assist with operating the one or more vehicles. For example, the remote operator may use this information to proactively slow the vehicle before entering an area of the road that has rough terrain or other road conditions.

### System and Method for Avoiding Areas in Poor Communication for Teleoperated and Autonomous Vehicle Operations

In embodiments, a remotely operated vehicle may rely on wireless connectivity for successful operation. The present invention recognizes that connection quality in one or more inventory management facilities may be very dynamic. For example, the quality of a wireless signal may be affected by one or more stacks of intermodal containers, which may be constantly moving and shifting within a yard. In embodiments, the system and method are configured such that the operator console displays geo-located connectivity information to the remote operator on the map view such that the remote operator may minimize or avoid remotely operating a vehicle in those areas of the inventory management facility, for example, whenever possible.

### Heads-Up Object Classification for Optimizing Teleoperated Vehicle Operations

In embodiments, the system and method are configured such that one or more vehicles (e.g., yard trucks) include one or more sensors. The one or more sensors include, for example, one or more cameras mounted on the vehicle a (e.g., used for remote driving). A remote operator can operate the vehicle based on viewing video streams transmitted to the control station from the cameras and displayed on a display of the operator console. In embodiments, the system and method employ an AI software algorithm that uses sensor data from the one or more cameras to identify one or more objects in the vehicle's environment, such as other vehicles, assets, humans, etc. In embodiments, the system and method are configured such that the one or more objects is identified in the video stream displayed to the remote operator. For example, the one or more objects is identified in the video stream by a bounding box drawn around the object. In an example, the one or more objects is identified by a label identifying the object. In this way, the system and method provide additional situational awareness for the remote operator.

### Using Ambient External Audio Feedback in Remotely Operated and Autonomous Vehicle Operations

The present invention recognizes that an operator of a remotely operated vehicle typically may not be able to have access to auditory sensory feedback such as the sound of engine RPMs, horns from other vehicles, etc., while operating the vehicle. In embodiments, the system and method include one or more audio sensors, such as microphones and/or transducers located onboard the vehicle and configured to transmit audio sensor data to the operator console. For example, the system and method are configured to stream ambient environmental noise to the remote operator from one or more microphones and/or transducers located on the vehicle to provide the remote operator with increased situational awareness.

### Using Automated Queuing to Enhance Teleoperated Vehicle Operations

In embodiments, the system and method notifies the remote operator, or another remote operator (i.e., a different remote operator), when a vehicle is ready to advance in a queue. The notified remote operator can connect to the vehicle and operate the vehicle to advance the vehicle in the queue. In embodiments of the system and method, the vehicle is configured to autonomously advance (e.g., drive or move) in the queue. In embodiments, the system and method notifies the remote operator, or another remote operator, when the vehicle has reached the end of the queue. The autonomous movement of the vehicle can be terminated or at least temporarily ceased, and the notified remote operator can connect to the vehicle and assume operational control of the vehicle to perform the assigned workflow for the vehicle.

Intelligent Vehicle Operation that combines A-to-B Autonomous Navigation with Teleoperation

In embodiments, the system and method are configured to provide a combination of autonomous navigation (e.g., autonomous operation of the vehicle from a first location, or point A, to a second location, or point B, of a workflow route) with teleoperation. For example, the system and method provide fractional or partial autonomy and/or fractional or partial automation. This is similar to a situation where a pilot controls an airplane during takeoff and landing, but auto pilot controls the plane at cruising altitude. In embodiments, the vehicle is configured to autonomously navigate the vehicle, for example from point A to point B. When the vehicle arrives at an end of a workflow route (e.g., point B), a remote operator can connect to the vehicle and assume operational control of the vehicle to perform operations (e.g., complicated operations) at the end points of a workflow route. In embodiments, a remote operator is notified when the vehicle arrives at an end of a workflow route (e.g., point B) such that control of the vehicle can be transitioned from autonomous operation to operation by the remote operator.

Optimizing Vehicle Operations Using Automated Trailer Reversing with Teleoperation

In embodiments, the system and method are configured to provide fractional or partial autonomy and/or fractional or partial automation. In embodiments, the vehicle (e.g., a yard truck) is configured to autonomously navigate the vehicle along a workflow route, for example, from point A to point B. When the vehicle arrives at an end of a workflow route (e.g., point B), a remote operator can connect to the vehicle and assume operational control of the vehicle. In embodiments, a remote operator is notified when the vehicle arrives at an end of a workflow route (e.g., point B). After arriving at a destination, the remote operator can initiate autonomous operation of the vehicle (e.g., autonomous reversing) to reverse the vehicle such a trailer coupled to the vehicle can be moved into a destination location, such as a dock door, a parking spot, or the like.

Optimizing Vehicle Operations using Automated Trailer Connecting with Teleoperation

In embodiments, the system and method are configured to provide fractional or partial autonomy and/or fractional or partial automation. In embodiments, the vehicle is configured to autonomously navigate the vehicle along a workflow route, for example, from point A to point B. When the vehicle arrives at an end of a workflow route (e.g., point B), a remote operator can connect to the vehicle and assume operational control of the vehicle. In embodiments, a remote operator is notified when the vehicle arrives at an end of a workflow route (e.g., point B). The remote operator can operate the vehicle (e.g., a yard truck) to align, or at least partially or roughly align, the vehicle with a trailer. The remote operator then can initiate autonomous reversing of the vehicle to navigate the vehicle into position to connect the vehicle to the trailer.

### Haptic Feedback for Teleoperated and Autonomous Vehicle Operations

In embodiments, the system and method are configured to provide haptic feedback, such as via a steering wheel or seat vibrations, at the remote operator console to increase the remote operator's situational awareness.

### User-Tunable Video Stitching for Teleoperated and Autonomous Vehicle Operations

In embodiments, the system and method are configured to stitch a plurality of video streams together to thereby increase visibility for the remote operator. The present invention recognizes that a problem with stitching on mobile platforms is the tendency for camera positions to change, even if only slight changes, due to vibrations and impacts of the vehicle while operating (e.g., driving around). In embodiments, the system and method are configured to provide the remote operator with the ability to initiate and validate a re-configuration during vehicle operations.

### Guidelines for Teleoperated and Autonomous Vehicle Operations

In embodiments, the system and method are configured to display overlaying guidelines to the operator on the display of the operator console to show additional information related to the vehicle, such as the vehicle's trajectory and/or an assets trajectory (e.g., a trailer's trajectory), for example, when the vehicle is in reverse, thereby providing the remote operator with additional situational awareness.

### Increased Situational Awareness for Reversing a Teleoperated Vehicle

In embodiments, the system and method include one or more lasers, lights, and/or other visualization for viewing a vehicle path and/or a trailing path when reversing to thereby assist with aligning the vehicle with the asset (e.g., trailer). For example, a laser device is provided on the vehicle and configured to transmit a laser beam from the rear of the vehicle to indicate a bounding box trajectory of the vehicle when reversing the vehicle in a direction of an asset (e.g., trailer), as shown in FIG. 11.

System and Method for Determining Alignment with Lift Equipment in a Teleoperated Vehicle Operation

In embodiments, the system and method include one or more lasers, lights, and/or other visualization for viewing a vehicle path and/or alignment with one or more other vehicles in the inventory management facility, for example, another vehicle such as lift equipment for moving assets, to thereby assist with aligning the vehicle with the other vehicle or lift equipment. For example, a laser device is provided on a vehicle and configured to transmit a laser beam from the vehicle to indicate a bounding box trajectory of the vehicle when moving the vehicle in a direction of one or more other vehicles, such as lift equipment, including, for example, a sideloader, a toploader, a gantry crane such as a Rubber Tired Gantry Crane (RTG), or other lift equipment.

### System and Method for Tracking Presence and Alertness of Teleoperated Vehicle Operator

In embodiments, the system and method include one or more sensors, such as one or more cameras, at the control station, such as on the operator console. For example, one or more cameras can face an operator using the operator console to remotely control one or more vehicles in one or more inventory management facilities. The system and method employ one or more algorithms (e.g., AI algorithms) configured to use the image date from the camera and/or other sensor information to assess fatigue and/or distraction of the remote operator.

### System and Method for Monitoring Safe and Efficient Teleoperated Driving

In embodiments, the system and method include one or more sensors on the vehicle to monitor operation of the vehicle, such as harsh braking, harsh turning, and/or other operating metrics data of the vehicle. The system and method use the data associated with the operating metrics of the remote operator to train a remote operator, for example, either after post-processing the data and/or by displaying suggestions to the operator in real time. The system and method use the data associated with the operating metrics of the remote operator to characterize and/or determine qualities and/or scoring associated with an operator, such as classifying the data as a good remote operator profile, a below average remote operator profile, etc. The system and method use the data associated with the operating metrics of the remote operator to provide predictive accident information and/or initiate supervisor intervention. In these ways, the embodiments provide additional feedback to a remote operator, monitoring of performance of a remote operator, and/or supervision of a remote operator, among other things, to improve the operation of the vehicle by the remote operator in the absence of, or limited, sensory feedback available to a remote operator by virtue of not being physically present on the vehicle during operation, such as the absence of exposure to the inertial movement of the vehicle.

### Remote Site Comms for Remotely Operated Vehicles

The present invention recognizes that inventory management facilities may rely heavily on local 2-way radio communications. In embodiments, the system and method are configured such that, when a remote operator connects to a vehicle and assumes operational control of the vehicle, the remote operator can be provided with the ability to connect to the local 2-way radio communications of the one or more inventory management facilities associated with the tasks and/or workflow for the vehicle.

### Automatically Changing Camera Views Based on Situational Context

In embodiments, the system and method are configured such that the operator console displays one or more camera views to a remote operator, and more particularly, one or more camera views based on the operation of the vehicle. For example, the operator console is configured to display forward facing cameras when the vehicle transmission is put in drive/forward position, reverse cameras when the vehicle transmission is put in reverse position, and/or show side cameras when the vehicle's turn indicator is activated and/or when a steering wheel of the operator console is turned, among other things.

### Collision Avoidance

With reference again to FIGS. 1-12, exemplary embodiments of a system for, and method of, remotely operating of one or more vehicles in one or more inventory management facilities, will now be described.

### System and Method for Collision Avoidance in Teleoperated Vehicle Operations

In embodiments, the system for, and method of, remotely operating one or more vehicles, such as a yard truck, in one or more inventory management facilities, includes a control station in communication with the one or more vehicles. The control station includes, for example, an operator console. The one or more vehicles include one or more sensors or sets of sensors and/or one or more computers on the vehicle. The computer is in communication with the one or more sensors, and include one or more processors and one or more non-transitory computer-readable storage mediums storing instructions comprising one or more algorithms that when executed by the one or more processors cause the one or more processors to perform steps to detect one or more objects around the teleoperated vehicle (e.g., in an environment of the teleoperated vehicle), as shown for example in FIG. 12. The one or more processors are configured such that, if one or more objects are detected, the object detection subsystem issues commands to alter the vehicle movement, such as to slow or stop the vehicle. The one or more processors are configured such that, if at the same time, the remote operator is issuing commands to increase vehicle speed in contradiction to the commands from the object detection subsystem, then an arbitration algorithm arbitrates between commands received by the remote operator and the object detection subsystem and determines which command or commands to issue to the vehicle for vehicle operation.

### Visualizing Sensor Zones for Improving Teleoperated and Autonomous Vehicle Operations

In embodiments, the system for, and method of, remotely operating one or more vehicles, such as a yard truck, in one or more inventory management facilities, includes a control station in communication with the one or more vehicles. The control station includes, for example, an operator console. The one or more vehicles includes one or more sensors or sets of sensors on the vehicle, such as one or more object detection sensors, for example, radar and/or lidar, etc., as shown for example in FIG. 10.

The control station includes a computer or server or a combination thereof in communication with the one or more sensors, and includes one or more processors and one or more non-transitory computer-readable storage mediums storing instructions comprising one or more algorithms that when executed by the one or more processors cause the one or more processors to perform steps to detect one or more objects around the teleoperated vehicle (e.g., in an environment of the teleoperated vehicle) based on the senor data from the object detection sensors.

In embodiments, the control station is configured to overlay one or more scan zones of the one or more object detection sensors on the display of the operator console to provide the remote operator with additional situational awareness.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in FIGS. 1-12 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor reads information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description herein should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

1. A system for remotely operating one or more vehicles in one or more inventory management facilities including one or more assets, the system comprising:
the one or more vehicles configured to move one or more assets in the one or more inventory management facilities from a first location to a second location; and
a control station in communication with the one or more vehicles,
wherein the control station is remote from the one or more vehicles and communicates at least one operational command to the one or more vehicles to operate the one or more vehicles to perform one or more assigned tasks and/or operational workflows for the one or more vehicles.

2. The system of claim 1, wherein the one or more assigned tasks and/or operational workflows for the one or more vehicles includes moving a first asset of the one or more assets in the one or more inventory management facilities from a first location in the one or more inventory management facilities to a second location in the one or more inventory management facilities.

3. The system of claim 1, wherein the control station includes an operator console.

4. The system of claim 1, wherein the one or more vehicles includes at least one of a ground vehicle, a yard truck, a truck, a semi, a hostler, a yard checker, a terminal tractor, a bobtail, a forklift, a pallet mover, a sideloader, a toploader, a Rubber Tired Gantry Crane (RTG), or a remote-controlled locomotive, or combinations thereof.

5. The system of claim 1, wherein the one or more inventory management facilities includes at least one of a shipping yard, an industrial yard, a container terminal, an intermodal yard, a container freight station, a warehouse, an order fulfillment facility, a depot, a distribution center, a logistics park or facility, a shop bay, a port, a terminal, a container ship, a railyard, a railroad classification yard, or a distribution point downstream thereof, or combinations thereof, or a part, segment, area, zone, and/or region thereof.

6. The system of claim 1, wherein the inventory management facility includes at least one of:
an entry point,
an exit point,
an operating area,
a staging area,
a storage area,
a loading and/or unloading area, or
a maintenance area,
or combinations of any two or more thereof,
defining a part of a boundary of the inventory management facility or a part, segment, area, zone, and/or region of the inventory management facility.

7. A method of remotely operating one or more vehicles in one or more inventory management facilities including one or more assets, the method comprising the steps of:
initiating a connection to a first vehicle of the one or more vehicles;
assuming operational control of the first vehicle; and
performing one or more assigned tasks and/or operational workflows for the first vehicle.

8. The method of claim 7, wherein the step of performing one or more assigned tasks and/or operational workflows for the first vehicle includes moving a first asset of the one or more assets in the one or more inventory management facilities from a first location in the one or more inventory management facilities to a second location in the one or more inventory management facilities.

9. A server for controlling remotely operating one or more vehicles in one or more inventory management facilities including one or more assets, wherein the server is in communication with one or more sensors configured to generate sensor data of the one or more assets in the inventory management facility, the server comprising:
one or more processors and one or more non-transitory computer-readable storage mediums storing instructions comprising one or more algorithms that when executed by the one or more processors cause the one or more processors to perform steps to:
initiate a connection to a first vehicle of the one or more vehicles;
assume operational control of the first vehicle; and
perform one or more assigned tasks and/or operational workflows for the first vehicle.

10. The server of claim 9, wherein the step of performing one or more assigned tasks and/or operational workflows for the first vehicle includes moving a first asset of the one or more assets in the one or more inventory management facilities from a first location in the one or more inventory management facilities to a second location in the one or more inventory management facilities.
